(19) United States
(12) Patent Application Publication
(10) Pub. No.: US 2013/0255509 A1
(43) Pub. Date: Oct. 3, 2013

(54) ELECTRIC PRESSURE COOKER WITH REMOVABLE FLIP COVER

(71) Applicants: Zhigang He, Foshan (CN); Zhibin Huang, Foshan (CN)

(72) Inventors: Zhigang He, Foshan (CN); Zhibin Huang, Foshan (CN)

(73) Assignees: Zhibin Huang, Foshan (CN); Zhigang He, Foshan (CN)

(21) Appl. No.: 13/825,968

(22) PCT Filed: Dec. 22, 2011
(86) PCT No.: PCT/CN2011/084421

§ 371 Date: Mar. 25, 2013

(30) Foreign Application Priority Data
Dec. 24, 2010 (CN) 201020680035.1

(51) Int. Cl. A47J 27/08

(52) U.S. Cl. CPC A47J 27/0804
USPC 99/352

(57) ABSTRACT

Disclosed is an electric pressure cooker with a removable flip cover comprising a cooker body (1) and cooker cover (2), wherein a supporting arm (3) is provided on the surface of the cooker cover (2), a positioning seat (5) corresponding to the supporting arm (3) is arranged at the edge of the cooker body (1), a positioning and supporting point (7) is provided on the positioning seat (5), and the lower part of the supporting arm (3) movably slips over and slidably contacts the positioning and supporting point (7). The electric pressure cooker has a simple structure and it is convenient to wash the flip cover without the need for special parts.

### TECHNICAL FIELD

The present utility model relates to the technical field of electric pressure cooker, particularly to an electric pressure cooker with removable cover.

### BACKGROUND ART

Featured by exquisite appearance, energy saving and high efficiency, electric pressure cookers are suitable for a variety of cooking methods, thus gaining increasing popularity among people. An electric pressure cooker generally includes a cover and a body, wherein a heater and an inner container are provided in the cooker body, the cover is connected with the cooker body through an engaging fastener, and a seal ring is used to seal the mouth of the inner container. During use, the cover of the electric pressure cooker can be engage with or disengaged from the cooker body through rotation of the cover, so as to close or open the cover. Generally, it is necessary to disengage the cover from the cooker body to open the cover, for example, the utility model named Electric Pressure Cooker with Sliding Spring Plate (Chinese Patent Application No.: CN201010169228.5), which comprises a cooker body, an inner container, a cook cover, a base and an electric hot tray; the inner container is arranged in the cooker body, the electric hot tray is arranged in the base, and the inner bottom of the middle layer close to the sidewall is provided with an even number of convex plates; the sliding spring plate and the convex column on the electric hot tray are connected with the convex plates; and a pressure switch is arranged on the bottom of the outer side of the middle layer. The patent has stable performance and can achieve precise pressure control, but it is inconvenient to remove the cover from the cooker body in the case of cooker cover repair or cleaning; another example is the utility model named Cover Structure of Electric Pressure Cooker (Chinese Patent Application No.: CN200910040845.2), wherein the cooker cover and the supporting arm can be quickly removed from the cooker body through said quickly removable hinge mechanism if cooker cover repair or cleaning is required, but its disadvantages include the need of special parts, complex structure and high manufacturing cost.

### DISCLOSURE OF THE INVENTION

### Technical Problems

The purpose of the utility model is to provide an electric pressure cooker with removable flip cover featured by simple structure, high productivity, easy disassembly and fitness for mass production, so as to solve the existing technical deficiencies.

### Technical Solution

This utility model adopts the following technical solution to achieve said purpose: An electric pressure cooker with removable flip cover, comprising a cooker body and a cooker cover, wherein a supporting arm is provided on the surface of the cooker cover, characterized in that a positioning seat corresponding to the supporting arm is arranged at the edge of the cooker body, two positioning and supporting points are provided on the positioning seat, and the lower part of the supporting arm movably slips over and slidably contacts the positioning and supporting points.

Furthermore, the surface of said positioning seat is provided with an arc-shaped chute, and two positioning and supporting points are arranged in the arc-shaped chute.

Two positioning and supporting points are provided on the positioning seat, the lower part of the supporting arm is provided with a cooker cover sliding chute corresponding to the two positioning and supporting points, and the cooker cover sliding chute takes the two positioning and supporting points as the flipping axis at the time of cover flipping.

Said cooker cover sliding chute is arc-shaped, and one side edge of the arc-shaped chute extends outward horizontally; when the cover flips to the set degree, the edge contacts the surface of the positioning seat to stop further flipping.

The opening direction of said cooker cover sliding chute is downward vertically.

Said positioning and supporting point is column-shaped, and the inner circle diameter of the cooker cover sliding chute is greater than the outer diameter of the positioning and supporting point.

Said supporting arm is provided with a release valve and a float valve, and the cover is provided with the release holes corresponding to the release valve and the float valve.

Said positioning seat and the positioning and supporting points thereof are arranged at the upper edge of the cooker body in an integrally molded manner, and the supporting arm is attached to the surface of the cooker cover in a detachable manner.

### Beneficial Effects

In this utility model, a positioning seat is arranged at the edge of the cooker body, and two positioning and supporting points are provided on the positioning seat and connected with the supporting arm of the cover in a pivotal manner; meanwhile, the supporting arm can pass through the positioning and supporting points and move rotatably. The flip cover has a simple structure and it is convenient to remove and clean the cover without the need for special parts.

### BRIEF DESCRIPTION OF THE DRAWINGS

FIG. 1 is a schematic view of the utility model with the cover locked;

FIG. 2 is a schematic top view of FIG. 1;

FIG. 3 is a schematic view of the utility model with the cover unlocked;

FIG. 4 is a schematic top view of FIG. 3;

FIG. 5 is a schematic view of cover removal of the utility model;

FIG. 6 is a schematic view of cover flipping of the utility model;

FIG. 7 is a schematic view of the cooker cover of the utility model;

FIG. 8 is a schematic view of the cooker body of the utility model

### DESCRIPTION OF NUMBER DESIGNATIONS IN THE ACCOMPANYING DRAWINGS

1. Cooker body 2. Cooker cover 3. Supporting arm 3-1 Cooker cover sliding chute 4. Release valve 5. Positioning base 6. Arch-shaped chute 7. Positioning and supporting point 8. Float valve

### DETAILED DESCRIPTION OF THE PREFERRED EMBODIMENTS

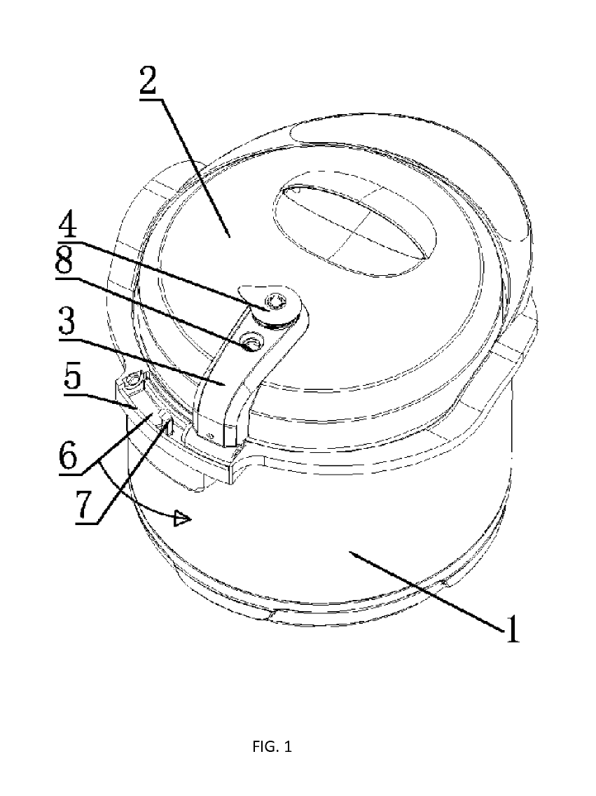

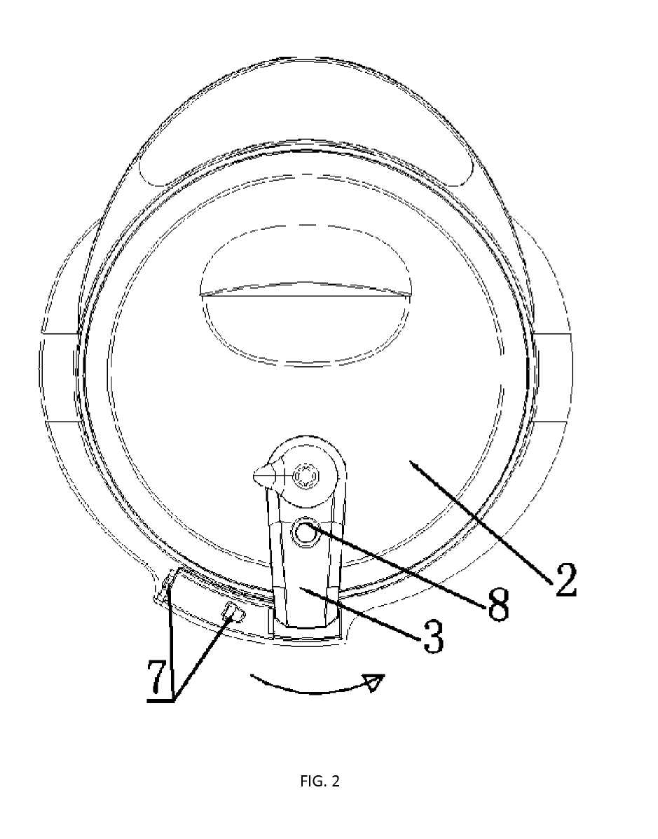

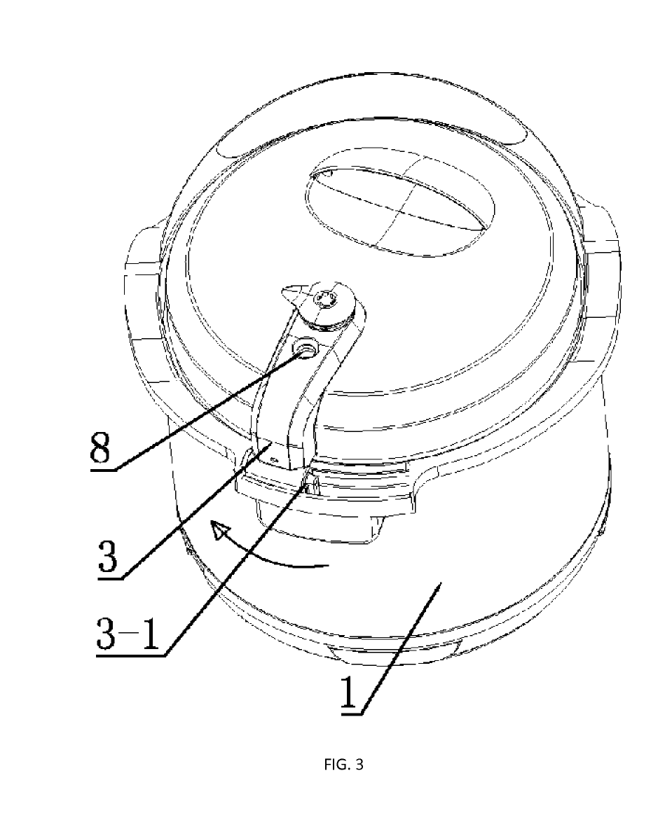

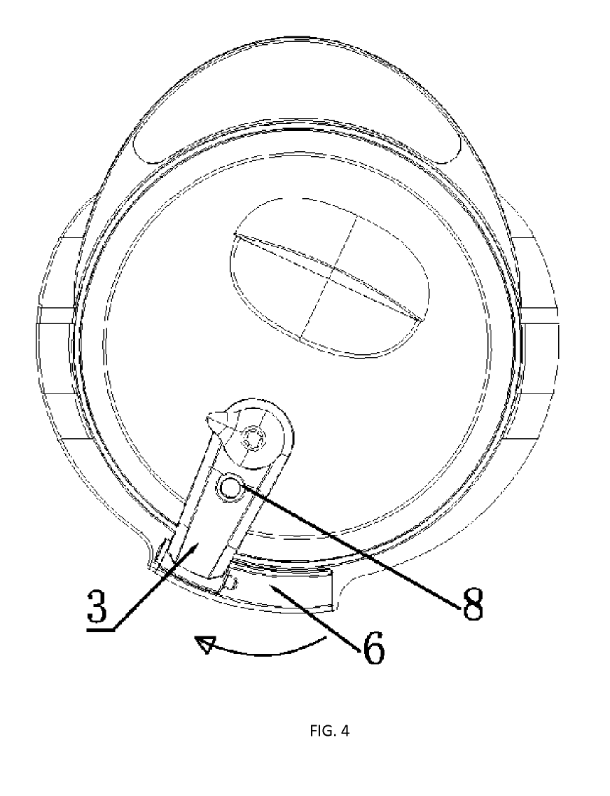

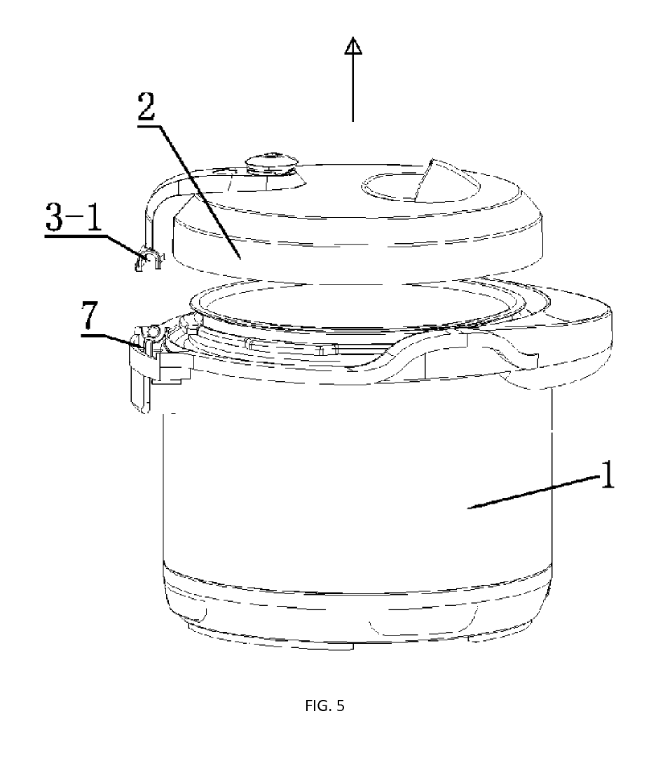

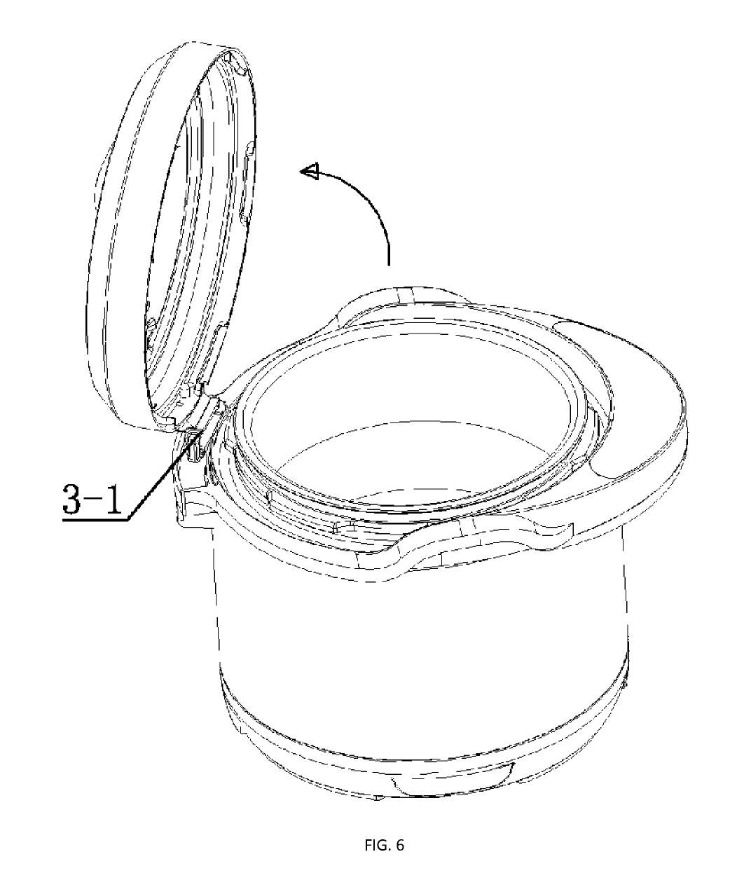

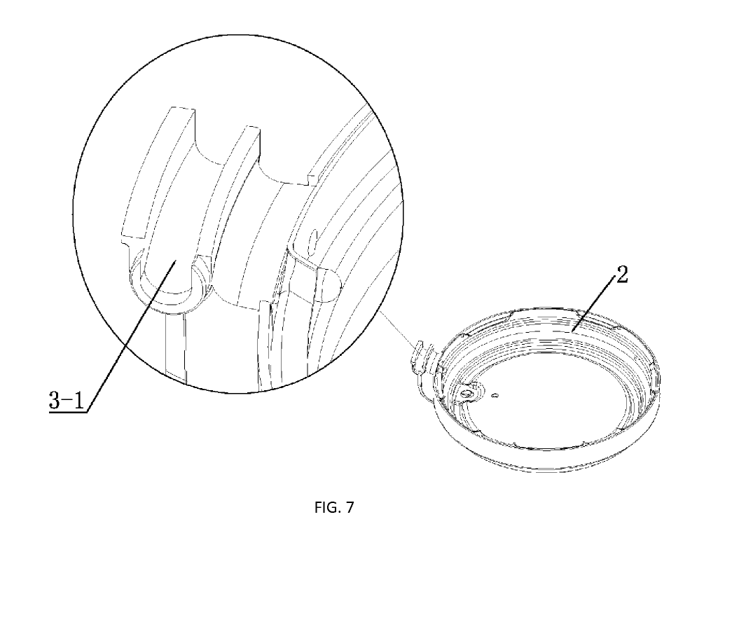

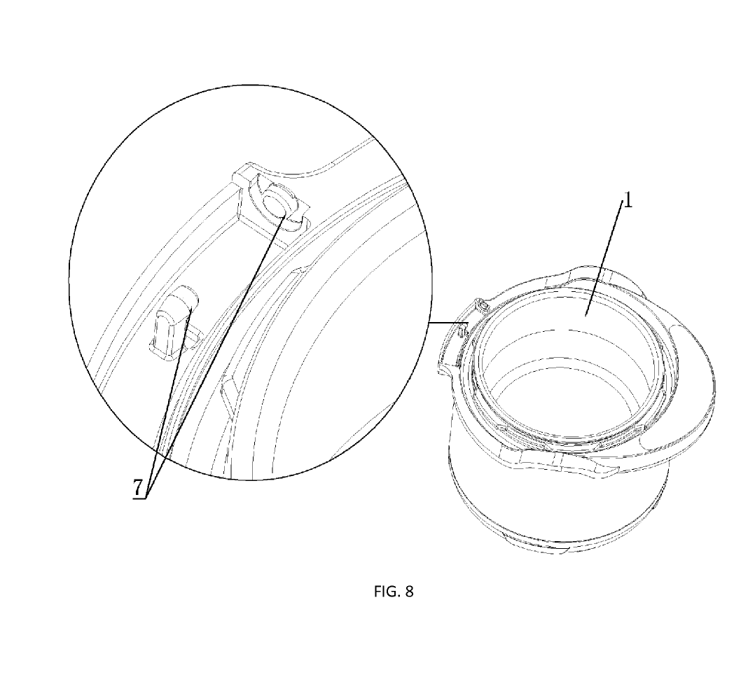

As illustrated in FIGS. 1-8, the utility model discloses an electric pressure cooker with removable flip cover, comprising a cooker body 1 and a cooker cover 2, wherein a supporting arm 3 is provided on the surface of the cooker cover 2, the supporting arm 3 is provided with a release valve 4 and a float valve 8, and the cooker cover is provided with the release holes corresponding to the release valve 4 and the float valve 8. A positioning seat 5 corresponding to the supporting arm is arranged at the edge of the cooker body 1, the surface of the positioning seat 5 is provided with an arc-shaped chute 6, and two positioning and supporting points 7 are arranged in the arc-shaped chute 6. The lower part of the supporting arm 3 movably slips over and slidably contacts the positioning and supporting points 7. In this embodiment, the lower part of the supporting arm 3 is provided with a cooker cover sliding chute 3-1 corresponding to the two positioning and supporting points, and the cooker cover sliding chute 3-1 takes the two positioning and supporting points as the flipping axis. The positioning and supporting point 7 is column-shaped, the inner circle diameter of the cooker cover sliding chute is greater than the outer diameter of the positioning and supporting point, and the opening direction of the cooker cover sliding chute is downward vertically. The positioning seat and the positioning and supporting points thereof are arranged at the upper edge of the cooker body in an integrally molded manner, and the supporting arm is attached to the surface of the cooker cover in a detachable manner.

When locking the cooker cover, you just need to rotate the cooker cover counterclockwise, then the cooker cover sliding chute on the supporting arm of the cooker cover slides along the arc-shaped chute arranged at the edge of the cooker body, and then the cooker cover sliding chute moves away from the positioning and supporting points and enters the locking zone to lock the cooker cover; on the contrary, when unlocking the cooker cover, you just need to rotate the cooker cover clockwise, and then the cooker cover sliding chute on the supporting arm of the cooker cover slides along the arc-shaped chute arranged at the edge of the cooker body; as the cooker cover sliding chute movably slips over and slidably contacts the two positioning and supporting points, at this moment, you can choose to lift the cooker cover vertically to remove it, or flip over the cooker cover around the two positioning and supporting points to open it.

Said embodiment is only a preferred embodiment of this utility model, and it should be noted that certain modifications and improvements can be made by those of ordinary skill in the art without departing from the creative concept of this utility model, which also fall within the scope of protection of this utility model.

What is claimed is:

1. An electric pressure cooker with removable flip cover, comprising a cooker body and a cooker cover, wherein a supporting arm is provided on the surface of the cooker cover, characterized in that a positioning seat corresponding to the supporting arm is installed at the edge of the cooker body, two positioning and supporting points are provided on the positioning seat, and the lower part of the supporting arm movably slips over and slidably contacts the positioning and supporting points.

2. The electric pressure cooker with removable flip cover of claim 1, characterized in that the surface of said positioning seat is provided with an arc-shaped chute, and two positioning and supporting points are installed in the arc-shaped chute.

3. The electric pressure cooker with removable flip cover of claim 1 or 2, characterized in that two positioning and supporting points are provided on the positioning seat, the lower part of the supporting arm is provided with a cooker cover sliding chute corresponding to the two positioning and supporting points, and the cooker cover sliding chute takes the two positioning and supporting points as the flipping axis.

4. The electric pressure cooker with removable flip cover of claim 3, characterized in that said cooker cover sliding chute is arc-shaped, and one side edge of the arc-shaped chute extends outward horizontally; when the cover flips to the set degree, the edge contacts the surface of the positioning seat to stop further flipping.

5. The electric pressure cooker with removable flip cover of claim 4, characterized in that the opening direction of said cooker cover sliding chute is downward vertically.

6. The electric pressure cooker with removable flip cover of claim 1, characterized in that said positioning and supporting point is column-shaped, and the inner circle diameter of the cooker cover sliding chute is greater than the outer diameter of the positioning and supporting point.

7. The electric pressure cooker with removable flip cover of claim 1, characterized in that said supporting arm is provided with a release valve and a float valve, and the cover is provided with the release holes corresponding to the release valve and the float valve.

8. The electric pressure cooker with removable flip cover of claim 1, characterized in that said positioning seat and the positioning and supporting points thereof are installed at the upper edge of the cooker body in an integrally molded manner, and the supporting arm is attached to the surface of the cooker cover in a detachable manner.
